(19) United States
(12) Patent Application Publication
(10) Pub. No.: US 2025/0033791 A1
(43) Pub. Date: Jan. 30, 2025

(54) SYSTEMS AND METHODS FOR ENSURING ACCURATE ENTRY OF QNH WITH RESPECT TO AN AVIONICS SYSTEM OF AN AIRCRAFT

(71) Applicant: THE BOEING COMPANY, Arlington, VA (US)

(72) Inventors: Kapil Rathi, Bengaluru (IN); Francis Bosco Innasi, Bangalore (IN); Ravathy Radhakrishnan, Bengaluru (IN); Spurthi Chennarayapatna Sundaresh, Bangalore (IN)

(73) Assignee: THE BOEING COMPANY, Arlington, VA (US)

(21) Appl. No.: 18/357,382

(22) Filed: Jul. 24, 2023

(51) Int. Cl. B64D 43/00; G08G 5/00

(52) U.S. Cl. CPC B64D 43/00; G08G 5/0013

(57) ABSTRACT

A system and a method include a control unit configured to compare first QNH data received from a first QNH data source, second QNH data received from a second QNH data source that differs from the first QNH data source, and a QNH input entered into an avionics system of an aircraft. The control unit is further configured to output an alert signal in response to the QNH input differing from one or both of the first QNH data or the second QNH data.

### FIELD OF THE DISCLOSURE

Examples of the present disclosure generally relate to systems and methods for ensuring accurate entry of QNH with respect to an avionics system of an aircraft.

### BACKGROUND OF THE DISCLOSURE

Aircraft are used to transport passengers and cargo between various locations. Numerous aircraft depart from and arrive at a typical airport every day.

QNH is the pressure setting used by pilots, air traffic control, and low frequency weather beacons to refer to the barometric setting which, when set on an altimeter, causes the altimeter to read altitude above mean sea level within a certain defined region. The letter Q signifies a question, and NH represents nautical height. Typically, the QNH value is verbally communicated to a pilot from air traffic control, and/or broadcast from the Automatic Terminal Information Service (ATIS). The pilot then manually enters the received QNH into the altimeter, for example.

Computation of altitude of an aircraft depends on accurate entry of the QNH by the pilot into the altimeter. The QNH value can differ with respect to various airports. As such, a current QNH is entered by the pilot at both a departure airport and an arrival airport. If an erroneous QNH is entered by a pilot, such as due to human error, there may be a mismatch between actual altitude and an altitude as determined by the altimeter. Therefore, the aircraft may be either above or below a pre-planned flight path, which can increase risk, such as during a landing procedure, and/or increase fuel consumption and flight time, as a go-around may be necessary due to the aircraft following an incorrect flight path for landing.

### SUMMARY OF THE DISCLOSURE

A need exists for a system and a method for ensuring accurate entry of QNH into an avionics system of an aircraft. Further, a need exists for a system and a method for eliminating, minimizing, or otherwise reducing human error in relation to entry of QNH into an avionics system of an aircraft.

With those needs in mind, certain examples of the present disclosure provide a system including a control unit configured to: compare first QNH data received from a first QNH data source, second QNH data received from a second QNH data source that differs from the first QNH data source, and a QNH input entered into an avionics system of an aircraft, and output an alert signal in response to the QNH input differing from one or both of the first QNH data or the second QNH data.

In at least one example, the control unit is further configured to output a confirmation signal in response to the QNH input matching both the first QNH data and the second QNH data.

In at least one example, the system also includes a user interface having a display within the aircraft. The control unit is further configured to show information regarding the alert signal on the display of the user interface. The information can include the first QNH data, the second QNH data, and the QNH input. The information can include a prompt to review and re-enter the QNH input into the avionics system.

In at least one example, the aircraft includes the control unit.

In at least one example, the first QNH data source is an Automatic Terminal Information Service (ATIS), and the second QNH data source is air traffic control (ATC).

The control unit can be further configured to automatically operate the aircraft based on a comparison of the first QNH data, the second QNH data, and the QNH input.

The control unit can be an artificial intelligence or machine learning system.

Certain examples of the present disclosure provide a method including comparing, by a control unit, first QNH data received from a first QNH data source, second QNH data received from a second QNH data source that differs from the first QNH data source, and a QNH input entered into an avionics system of an aircraft; and outputting, by the control unit, an alert signal in response to the QNH input differing from one or both of the first QNH data or the second QNH data.

Certain examples of the present disclosure provide a non-transitory computer-readable storage medium comprising executable instructions that, in response to execution, cause one or more control units comprising a processor, to perform operations comprising: comparing first QNH data received from a first QNH data source, second QNH data received from a second QNH data source that differs from the first QNH data source, and a QNH input entered into an avionics system of an aircraft; and outputting an alert signal in response to the QNH input differing from one or both of the first QNH data or the second QNH data.

### BRIEF DESCRIPTION OF THE DRAWINGS

FIG. 1 illustrates a schematic block diagram of a system, according to an example of the present disclosure.

FIG. 2 illustrates a flow chart of a method, according to an example of the present disclosure.

FIG. 3 illustrates a schematic block diagram of a control unit, according to an example of the present disclosure.

FIG. 4 illustrates a perspective front view of an aircraft, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

Examples of the present disclosure provide systems and methods that eliminate, minimize, or otherwise reduce a potential incorrect manual entry of QNH into an avionics system. In at least one example, the systems and methods include a control unit configured to receive QNH data from different sources. The control unit compares the QNH data from the different sources. If the QNH data from the different sources matches the QNH as input into an avionics system by a pilot, then the control unit determines that the QNH has been accurately entered. If, however, the QNH as input by the pilot does not match the QNH data from the different sources, the control unit outputs an alert indicating an error.

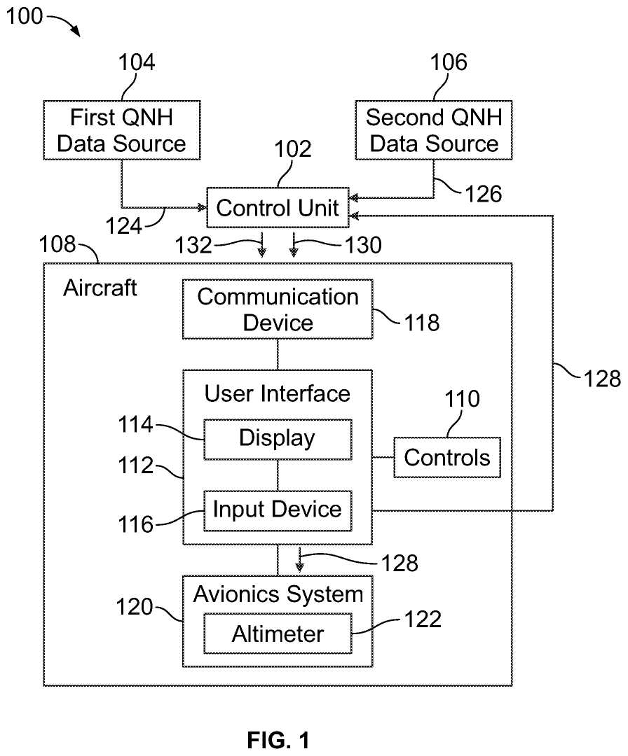

FIG. 1 illustrates a schematic block diagram of a system 100, according to an example of the present disclosure. The system 100 includes a control unit 102 in communication with a first QNH data source 104, and a second QNH data source 106, which differs from the first QNH data source 104, through one or more wired or wireless connections. For example, the control unit 102 is in communication with the first QNH data source 104 and the second QNH data source 106 through one or more antennas, transceivers, data networks, and/or the like. The control unit 102 can be remotely located from the first QNH data source 104 and the second QNH data source 106. Optionally, the control unit 102 can be at the same location as the first QNH data source 104 or the second QNH data source 106. In at least one other example, the control unit 102 can be onboard an aircraft 108, such as in communication with or part of a flight computer. That is, the aircraft 108 can include the control unit 102. As another example, the control unit 102 is remotely located from the aircraft 108, and is in communication with the aircraft 108 through one or more antennas, transceivers, data networks, and/or the like.

In at least one example, the first QNH data source 104 is an Automatic Terminal Information Service (ATIS), and the second QNH data source 106 is air traffic control (ATC). It is to be understood that the terms first and second are merely labels indicating two different sources of QNH data, and that ATC can be the first QNH data source 104, and ATIS can be the second QNH data source 106. Optionally, the QNH data sources can be other sources, such as other types of aviation reporting services.

The aircraft 108 includes controls 110 that one or more members of a flight crew operate to control operation of the aircraft 108. The aircraft 108 also includes a user interface 112, which can be part of, or otherwise in communication with, a flight computer. As another example, the user interface 112 can be part of a separate computer workstation aboard the aircraft 108. As another example, the user interface 112 can be a handheld device, such as a smart phone, tablet, or the like, within the aircraft 108. The user interface 112 includes a display 114, such as an electronic monitor, in communication with an input device 116, such as one or more of a keyboard, mouse, stylus, touchscreen interface, and/or the like. The aircraft 108 also includes a communication device 118, such as one or more antennas, transceivers, radios, and/or the like, such as allow the aircraft 108 to communicate with the first QNH data source 104, the second QNH data source 106, and/or the like. The aircraft 108 also includes an avionics system 120, which includes an altimeter 122. An individual, such as a pilot, enters QNH into the avionics system 120, such as into the altimeter 122. That is, the avionics system 120, such as including the altimeter 122, is configured to receive entry of QNH.

In operation, the first QNH data source 104 outputs first QNH data 124, which is received by the control unit 102 and the communication device 118 of the aircraft 108. For example, the first QNH data 124 is broadcast by ATIS in the form of voice information. In at least one example, the control unit 102 converts the first QNH data 124, which can be voice information, into text. In at least one example, the control unit 102 receives the first QNH data 124 as text data, such as when there is a datalink in relation to ATIS.

The second QNH data source 106 also outputs second QNH data 126, which is received by the control unit 102 and the communication device 118 of the aircraft 108. The second QNH data source 106 can output the second QNH data 126 at the same time as the first QNH data source 104 outputs the first QNH data 124. As another example, the second QNH data source 106 can output the second QNH data 126 before or after the first QNH data source 104 outputs the first QNH data 124. In at least one example, the second QNH data 126 is communicated to a pilot from ATC in the form of voice information. In at least one example, the control unit 102 converts the second QNH data 126, which can be voice information, into text. In at least one example, the control unit 102 receives the second QNH data 126 as text data, such as when there is a datalink in relation to ATC.

As noted, the aircraft 108 receives one or both of the first QNH data 124 and/or the second QNH data 126 via the communication device 118. In response to receiving the first QNH data 124 and/or the second QNH data 126, a QNH input 128 is entered into the avionics system 120, such as into the altimeter 122. For example, a pilot enters the QNH input 128, via the input device 116, into the avionics system 120. The control unit 102 also receives the QNH input 128, such as directly from the user interface 112, and/or from the avionics system 120.

The control unit 102 compares the first QNH data 124, the second QNH data 126, and the QNH input 128 to determine if all three match. If the control unit 102 determines that the first QNH data 124, the second QNH data 126, the QNH input 128 agree with one another (for example, match each other exactly or within a predetermined acceptable threshold, such as +/−0.1%), the control unit 102 determines that the QNH input 128 entered into the avionics system 120 is accurate. The control unit 102 can then output a confirmation signal 130 to the user interface 112. The confirmation signal 130 can be shown on the display 114 and/or broadcast through a speaker. The confirmation signal 130 includes information indicating that the QNH input 128 is accurate. The confirmation signal 130 as output by the control unit 102 and shown on the display 114 (and/or broadcast through a speaker) can include the first QNH data 124, the second QNH data 126, and the QNH input 128, thereby confirming to the pilot that all three values match, and the correct QNH has been input into the avionics system 120. Optionally, the control unit 102 may not output a confirmation signal.

If, however, the control unit 102 determines that one or more of the first QNH data 124, the second QNH data 126, and/or the QNH input 128 differ (that is, a mismatch in which the QNH input 128 differs from one or both of the first QNH data 124 and/or the second QNH data 126), the control unit 102 outputs an alert signal 132 to the user interface 112. The alert signal 132 can be shown on the display 114 and/or broadcast through a speaker. The alert signal 132 includes information indicating a potential error in the QNH input 128. The information can include the first QNH data 124, the second QNH data 126, and the QNH input 128, which can readily demonstrate to the pilot the existence of a mismatch in relation to the three values. In response, the pilot can then review the QNH input 128 and/or contact the first QNH data source 104 and/or the second QNH data source 106 to determine an accurate QNH for entry into the avionics system 120.

In at least one example, in response to the control unit 102 determining a mismatch in relation to the first QNH data 124, the second QNH data 126, and the QNH input 128, the alert signal 132 output by the control unit 102 includes a prompt that is shown on the display 114 (and/or broadcast through a speaker). The prompt includes a message indicating that the QNH input 128 needs to be reviewed, and a correct QNH needs to be entered. As an example, the control unit 102 may show the following prompt on the display: “Potential QNH error. Review QNH data and Input Correct QNH.”

In at least one example, the alert signal 132 output by the control unit 102 and shown on the display 114 (and/or broadcast through a speaker) includes the first QNH data 124, the second QNH data 126, and the QNH input 128. In this manner, the pilot can review both the first QNH data 124 and the second QNH data 126 to determine whether they match the QNH input 128 in order to determine whether the QNH input 128 is accurate or needs to be corrected.

In at least one example, the control unit 102 can automatically operate the aircraft 108 based on the comparison of the first QNH data 124, the second QNH data 126, and the QNH input 128. For example, in response to the control unit 102 determining that the first QNH data 124, the second QNH data 126, and the QNH input 128 match, the control unit 102 may output one or more control signals that automatically operate one or more controls 110 of the aircraft 108, such as via autopilot. As another example, in response to the control unit 102 determining a mismatch in relation to the first QNH data 124, the second QNH data 126, and the QNH input 128 (for example, the QNH input 128 differs from one or both of the first QNH data 124 and/or the second QNH data 126), the control unit 102 may output on or more control signals that automatically operate one or more controls 110, such as by preventing certain operations (for example, landing) until the QNH input 128 is correctly entered into the avionics system 120. In at least one other example, the control unit 102 may not automatically operate one or more controls 110 of the aircraft 108.

The systems and methods described herein increase safety and situational awareness. The system and methods are configured to determine potential QNH errors in advance of various flight operations, such as during departure, approach, and landing. Further, the systems and methods reduce fuel consumption and flight time in that they eliminate, minimize, or otherwise reduce last-minute go-arounds that could otherwise be caused by erroneous QNH.

As described herein, the system 100 includes the control unit 102, which is configured to compare the first QNH data 124 received from the first QNH data source 104, the second QNH data 126 received from the second QNH data source 106, and the QNH input 128 entered (such as by a pilot) into the avionics system 120 of the aircraft 108. The control unit 102 is further configured to output the alert signal 132 in response to the QNH input 128 differing from one or both of the first QNH data 124 or the second QNH data 126. The control unit 102 can also be configured to output the confirmation signal 130 in response to the QNH input 128 matching (such as exactly, or within a predetermined acceptable threshold) both the first QNH data 124 and the second QNH data 126. In at least one example, the system 100 also includes the user interface 112 within the aircraft 108. The control unit 102 shows information regarding the alert signal 132 on the display 114 of the user interface 112. As an example, the information includes a prompt to review and re-enter the QNH input 128 into the avionics system 120.

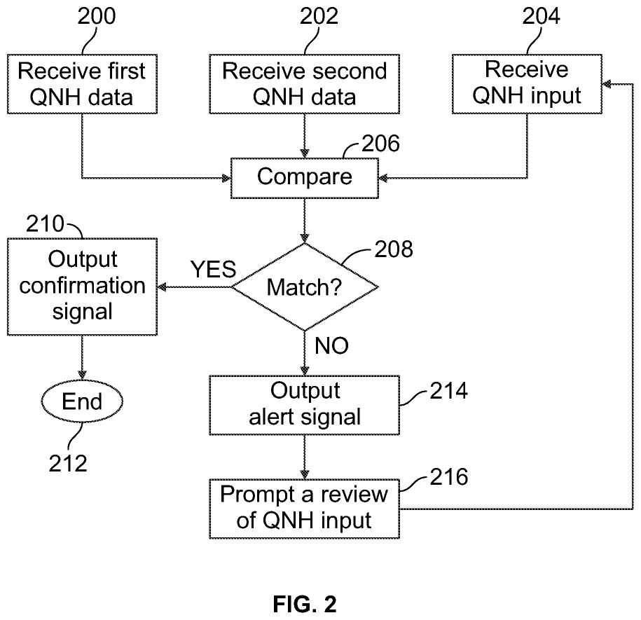

FIG. 2 illustrates a flow chart of a method, according to an example of the present disclosure. Referring to FIGS. 1 and 2, at 200, the control unit 102 receives the first QNH data 124, such as from the first QNH data source 104. At 202, the control unit 102 receives the second QNH data 126, such as from the second QNH data source 106. At 204, the control unit 102 receives the QNH input 128, such as entered into the avionics system 120 by a pilot. Steps 200, 202, and 204 can be concurrent, or at different times.

At 206, the control unit 102 compares the three values, namely the first QNH data 124, the second QNH data 126, and the QNH input 128. At 208, the control unit 102 determines if the three values match. If the values match, the method proceeds from 208 to 210, at which the control unit 102 outputs the confirmation signal 130, and then the method ends at 212. Optionally, in response to determining that the three values match, the method may proceed from 208 directly to 212, without the control unit 102 outputting a confirmation signal.

If, however, the three values do not match at 208 (that is, a mismatch in which the QNH input 128 differs from one or both of the first QNH data 124 and/or the second QNH data 126), the method proceeds to 214, at which the control unit 102 outputs the alert signal 132, and prompts a review of the QNH input 128 at 216. The method may then return to 204.

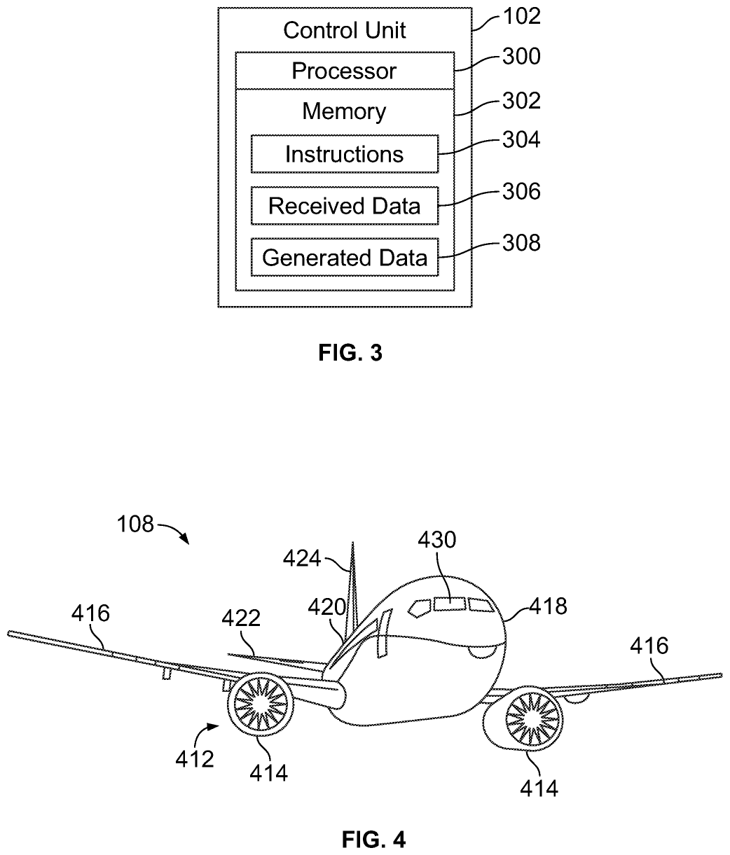

FIG. 3 illustrates a schematic block diagram of the control unit 102, according to an example of the present disclosure. In at least one example, the control unit 102 includes at least one processor 300 in communication with a memory 302. The memory 302 stores instructions 304, received data 306, and generated data 308. The control unit 102 shown in FIG. 3 is merely exemplary, and non-limiting.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the control unit 102 may be or include one or more processors that are configured to control operation, as described herein.

The control unit 102 is configured to execute a set of instructions that are stored in one or more data storage units or elements (such as one or more memories), in order to process data. For example, the control unit 102 may include or be coupled to one or more memories. The data storage units may also store data or other information as desired or needed. The data storage units may be in the form of an information source or a physical memory element within a processing machine.

The set of instructions may include various commands that instruct the control unit 102 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the control unit 102. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit 102 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

In at least one example, components of the system 100, such as the control unit 102, provide and/or enable a computer system to operate as a special computer system for providing situational awareness information for the aircraft 108, such as with respect to QNH. The control unit 102 improves upon standard computing devices by determining such information in an efficient and effective manner.

In at least one example, all or part of the systems and methods described herein may be or otherwise include an artificial intelligence (AI) or machine-learning system that can automatically perform the operations of the methods also described herein. For example, the control unit 102 can be an artificial intelligence or machine learning system. These types of systems may be trained from outside information and/or self-trained to repeatedly improve the accuracy with how data is analyzed to determine accurate QNH. Over time, these systems can improve by determining such information with increasing accuracy and speed, thereby significantly reducing the likelihood of any potential errors. For example, the AI or machine-learning systems can learn and determine QNH based on data received from different sources. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), and/or the like. The systems may be trained and re-trained using feedback from one or more prior analyses of the data, ensemble data, and/or other such data. Based on this feedback, the systems may be trained by adjusting one or more parameters, weights, rules, criteria, or the like, used in the analysis of the same. This process can be performed using the data and ensemble data instead of training data, and may be repeated many times to repeatedly improve the determination of the QNH. The training minimizes conflicts and interference by performing an iterative training algorithm, in which the systems are retrained with an updated set of data (for example, data received before, during, and/or after each flight of the aircraft 108) and based on the feedback examined prior to the most recent training of the systems. This provides a robust analysis model that can better determine accurate QNH in a cost effective and efficient manner.

FIG. 4 illustrates a perspective front view of an aircraft 108, according to an example of the present disclosure. The aircraft 108 includes a propulsion system 412 that includes engines 414, for example. Optionally, the propulsion system 412 may include more engines 414 than shown. The engines 414 are carried by wings 416 of the aircraft 108. In other examples, the engines 414 may be carried by a fuselage 418 and/or an empennage 420. The empennage 420 may also support horizontal stabilizers 422 and a vertical stabilizer 424. The fuselage 418 of the aircraft 108 defines an internal cabin 430, which includes a flight deck or cockpit, one or more work sections (for example, galleys, personnel carry-on baggage areas, and the like), one or more passenger sections (for example, first class, business class, and coach sections), one or more lavatories, and/or the like. FIG. 4 shows an example of an aircraft 108. It is to be understood that the aircraft 108 can be sized, shaped, and configured differently than shown in FIG. 4.

Further, the disclosure comprises examples according to the following clauses:
Clause 1. A system comprising:
   a control unit configured to:
      compare first QNH data received from a first QNH data source, second QNH data received from a second QNH data source that differs from the first QNH data source, and a QNH input entered into an avionics system of an aircraft, and
      output an alert signal in response to the QNH input differing from one or both of the first QNH data or the second QNH data.
Clause 2. The system of Clause 1, wherein the control unit is further configured to output a confirmation signal in response to the QNH input matching both the first QNH data and the second QNH data.
Clause 3. The system of Clauses 1 or 2, further comprising a user interface having a display within the aircraft, wherein the control unit is further configured to show information regarding the alert signal on the display of the user interface.
Clause 4. The system of Clause 3, wherein the information includes the first QNH data, the second QNH data, and the QNH input.
Clause 5. The system of Clauses 3 or 4, wherein the information includes a prompt to review and re-enter the QNH input into the avionics system.
Clause 6. The system of any of Clauses 1-5, wherein the aircraft includes the control unit.
Clause 7. The system of any of Clauses 1-6, wherein the first QNH data source is an Automatic Terminal Information Service (ATIS), and wherein the second QNH data source is air traffic control (ATC).
Clause 8. The system of any of Clauses 1-7, wherein the control unit is further configured to automatically operate the aircraft based on a comparison of the first QNH data, the second QNH data, and the QNH input.
Clause 9. The system of any of Clauses 1-8, wherein the control unit is an artificial intelligence or machine learning system.
Clause 10. A method comprising:
   comparing, by a control unit, first QNH data received from a first QNH data source, second QNH data received from a second QNH data source that differs from the first QNH data source, and a QNH input entered into an avionics system of an aircraft; and outputting, by the control unit, an alert signal in response to the QNH input differing from one or both of the first QNH data or the second QNH data.
Clause 11. The method of Clause 10, further comprising outputting, by the control unit, a confirmation signal in response to the QNH input matching both the first QNH data and the second QNH data.
Clause 12. The method of Clauses 10 or 11, further comprising showing, by the control unit on a display of a user interface within the aircraft, information regarding the alert signal.
Clause 13. The method of Clause 12, wherein the information includes the first QNH data, the second QNH data, and the QNH input.
Clause 14. The method of Clauses 12 or 13, wherein said showing comprises prompting a review and re-entry of the QNH input into the avionics system.
Clause 15. The method of any of Clauses 10-14, wherein the aircraft includes the control unit.
Clause 16. The method of any of Clauses 10-15, wherein the first QNH data source is an Automatic Terminal Information Service (ATIS), and wherein the second QNH data source is air traffic control (ATC).
Clause 17. The method of any of Clauses 10-16, further comprising automatically operating, by the control unit, the aircraft based on said comparing.
Clause 18. The method of any of Clauses 10-17, wherein the control unit is an artificial intelligence or machine learning system.
Clause 19. A non-transitory computer-readable storage medium comprising executable instructions that, in response to execution, cause one or more control units comprising a processor, to perform operations comprising:
   comparing first QNH data received from a first QNH data source, second QNH data received from a second QNH data source that differs from the first QNH data source, and a QNH input entered into an avionics system of an aircraft; and
   outputting an alert signal in response to the QNH input differing from one or both of the first QNH data or the second QNH data.
Clause 20. The non-transitory computer-readable storage medium of Clause 19, wherein the first QNH data source is an Automatic Terminal Information Service (ATIS), and wherein the second QNH data source is air traffic control (ATC).

As described herein, examples of the present disclosure provide systems and methods for ensuring accurate entry of QNH into an avionics system of an aircraft. Further, examples of the present disclosure provide systems and methods for eliminating, minimizing, or otherwise reducing human error in relation to entry of QNH into an avionics system of an aircraft.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a control unit configured to:
compare first QNH data received from a first QNH data source, second QNH data received from a second QNH data source that differs from the first QNH data source, and a QNH input entered into an avionics system of an aircraft, and
output an alert signal in response to the QNH input differing from one or both of the first QNH data or the second QNH data.

2. The system of claim 1, wherein the control unit is further configured to output a confirmation signal in response to the QNH input matching both the first QNH data and the second QNH data.

3. The system of claim 1, further comprising a user interface having a display within the aircraft, wherein the control unit is further configured to show information regarding the alert signal on the display of the user interface.

4. The system of claim 3, wherein the information includes the first QNH data, the second QNH data, and the QNH input.

5. The system of claim 3, wherein the information includes a prompt to review and re-enter the QNH input into the avionics system.

6. The system of claim 1, wherein the aircraft includes the control unit.

7. The system of claim 1, wherein the first QNH data source is an Automatic Terminal Information Service (ATIS), and wherein the second QNH data source is air traffic control (ATC).

8. The system of claim 1, wherein the control unit is further configured to automatically operate the aircraft based on a comparison of the first QNH data, the second QNH data, and the QNH input.

9. The system of claim 1, wherein the control unit is an artificial intelligence or machine learning system.

10. A method comprising:
comparing, by a control unit, first QNH data received from a first QNH data source, second QNH data received from a second QNH data source that differs from the first QNH data source, and a QNH input entered into an avionics system of an aircraft; and
outputting, by the control unit, an alert signal in response to the QNH input differing from one or both of the first QNH data or the second QNH data.

11. The method of claim 10, further comprising outputting, by the control unit, a confirmation signal in response to the QNH input matching both the first QNH data and the second QNH data.

12. The method of claim 10, further comprising showing, by the control unit on a display of a user interface within the aircraft, information regarding the alert signal.

13. The method of claim 12, wherein the information includes the first QNH data, the second QNH data, and the QNH input.

14. The method of claim 12, wherein said showing comprises prompting a review and re-entry of the QNH input into the avionics system.

15. The method of claim 10, wherein the aircraft includes the control unit.

16. The method of claim 10, wherein the first QNH data source is an Automatic Terminal Information Service (ATIS), and wherein the second QNH data source is air traffic control (ATC).

17. The method of claim 10, further comprising automatically operating, by the control unit, the aircraft based on said comparing.

18. The method of claim 10, wherein the control unit is an artificial intelligence or machine learning system.

19. A non-transitory computer-readable storage medium comprising executable instructions that, in response to execution, cause one or more control units comprising a processor, to perform operations comprising:
comparing first QNH data received from a first QNH data source, second QNH data received from a second QNH data source that differs from the first QNH data source, and a QNH input entered into an avionics system of an aircraft; and
outputting an alert signal in response to the QNH input differing from one or both of the first QNH data or the second QNH data.

20. The non-transitory computer-readable storage medium of claim 19, wherein the first QNH data source is an Automatic Terminal Information Service (ATIS), and wherein the second QNH data source is air traffic control (ATC).
